(19) United States
(12) Patent Application Publication
(10) Pub. No.: US 2005/0107198 A1
(43) Pub. Date: May 19, 2005

(54) Hybrid powertrain

(76) Inventors: Henryk Sowul, Novi, MI (US); James D. Hendrickson, Belleville, MI (US); Michael B. Solt, Beverly Hills, MI (US)

Correspondence Address: General Motors Corporation;Legal Staff, Mail Code 482-C23-B21, P.O. Box 300, Detroit, MI, 48265-3000, US

(21) Appl. No.: 10/717,118

(22) Filed: Nov. 19, 2003

(51) Int. Cl. F16H 3/72

(52) U.S. Cl. 475/5

(57) ABSTRACT

A hybrid powertrain includes a prime mover engine driving a multi-ratio transmission. A gear transfer mechanism is connected between said transmission and a plurality of vehicle drive wheels. An electric power unit, such as a motor/generator is drivingly connected with the gear transfer mechanism in parallel power flow relation with an output power flow from said transmission.

### TECHNICAL FIELD

This invention relates to hybrid powertrains and, more particularly, to hybrid powertrains having a prime mover, a power transmission, and an electric drive motor providing an assist to the powertrain or the power flow from the prime mover. More particularly, this invention relates to hybrid powertrains wherein the electric motor can provide a drive to the vehicle wheels to the exclusion of the prime mover.

### BACKGROUND OF THE INVENTION

Hybrid type transmissions come in a variety of sizes or power levels including a mild hybrid, a semi-hybrid, and a full hybrid. The mild hybrid type of powertrain includes a motor/generator, which will provide engine start and regenerative braking during operation. These mild hybrids have low electrical power ratings and typically do not exceed six kilowatts. These systems generally connect a motor/generator to the engine through a belt or chain drive and are commonly referred to as belt-alternator-starter (BAS) hybrid. BAS systems work with conventional transmissions and therefore require little driveline change per conversion from a conventional to a mild hybrid propulsion unit.

A semi-hybrid system is slightly more powerful than the BAS system. These systems generally have power levels in the range of fifteen to twenty kilowatts. With a semi-hybrid powertrain, features such as motor assist and increased regenerative braking are possible. At least one design solution for a semi-hybrid attaches the electric motor output directly with the engine flywheel. This has a drawback in that the engine must spin with the electrical motor therefore reducing motor-only operation. These flywheel-alternator-starter (FAS) systems may be packaged around the torque converter or between the engine and transmission. Thus, the packaging is compact. The FAS systems typically utilize conventional transmissions with significant package changes to accommodate the increased envelope of the electric motor.

The full hybrid powertrains are generally electric-variable-transmissions (EVT). These EVT systems can be designed with a high ratio of electric-to-engine power, which is why they are designated as full hybrid systems. The EVT system allows increased freedom of power flow and will generally provide motor-only operation, which is more effective than a BAS or FAS system. At least one such full hybrid system is known to include an engine connected to a planetary member such as a carrier, a generator connected to another planetary member such as a ring gear, and an electric motor connected to a further planetary member such as a sun gear. Thus the engine, generator, and motor all connect into a single planetary system. Other full hybrid type systems employ an EVT connected with the input side of the continuously variable transmission (CVT).

Because of economic reasons, EVT systems have not been employed in conventional passenger car drive trains because such systems have required major driveline architecture modifications. In each of the hybrid systems described above, a common attribute can be found. In each of these systems, the primary electric motor or electric machine is located on the input side of the transmission. This power flow is typical because during motor drive operation, the transmission is used to multiply the electric motor torque to a level required for adequate vehicle acceleration.

During regenerative braking operation, the energy provided in the vehicle is routed through the transmission before arriving at the electric generator. One concern with this arrangement is that the effectiveness of the regenerated process is dependent upon the type of transmission used. For example, manual, stepped, automatic, or CVT. The transmission interposed between the output and the electric generator affects the speed of the generator due to the speed changes and interruptions within the transmission caused by downshifting. Another concern associated with input side full hybrids is the initial high cost of conversion from conventional systems. Packaging and power flow constraints generally mandate that the conventional transmission be replaced with a new unit driving the investment cost to a higher level.

### SUMMARY OF THE INVENTION

It is an object of the present invention to provide an improved full hybrid powertrain.

In one aspect of the present invention, an electric machine (motor/generator M/G) is attached directly to the output of the transmission through the gear mechanism.

In another aspect of the present invention, the electric machine and the reduction gear assembly connected therewith are packaged in a common case.

In yet another aspect of the present invention, the hybrid powertrain is employed within a front wheel drive powertrain application.

In still another aspect of the present, the full hybrid powertrain is employed in a rear wheel drive vehicle application.

In yet still another aspect of the present invention, the full hybrid powertrain is employed in an all wheel drive vehicle application wherein the rear wheels are the primary driven wheels.

In a yet still another aspect of the present invention, the electric machine has incorporated therewith a reduction gear mechanism including a planetary gearset.

In a further aspect of the present invention, the electric motor and included gearset have a double reduction planetary gearset and a selectively operable clutch disposed between the electric motor planetary gearset output and the powertrain input.

In a still further aspect of the present invention, the electric power unit is drivingly connected into the hybrid powertrain between the transmission output and the drive mechanism for the vehicle wheels.

In a yet still further aspect of the present invention, one portion of the hybrid powertrain includes an electric machine drivingly connected to the transmission output and to one pair of driving wheels of the vehicle and the other wheels of the vehicle have connected therewith other electric machines separate from the first mentioned electric machine.

### DESCRIPTION OF THE DRAWINGS

FIG. 1 is a diagrammatic representation of a hybrid powertrain incorporating the present invention.

FIG. 2 is another embodiment of the hybrid powertrain incorporating the present invention.

FIG. 3 is a diagrammatic representation of a hybrid powertrain having a front wheel drive powertrain incorporating the engine, transmission, and electric power machine, and the rear wheel drive powertrain incorporating a separate power mechanism.

FIG. 4 is another embodiment of the present invention wherein the front wheels of the vehicle incorporate a hybrid powertrain and the rear wheels of the vehicle incorporate electric drive powertrains.

FIG. 5 is a diagrammatic representation of a front wheel drive powertrain incorporating the present invention.

FIG. 6 is a further embodiment of the present invention incorporated into an all wheel drive application for a vehicle.

FIG. 7 is a diagrammatic representation of an electric drive unit incorporating a single reduction planetary gearset within the power flow.

FIG. 8 is a diagrammatic representation of another electric power unit incorporating a double reduction planetary gear arrangement and a selectively actuatable clutch mechanism.

FIG. 9 is a diagrammatic representation of a drive connection between the electric power unit and the output of the mechanical transmission incorporated within a hybrid power powertrain.

FIG. 10 is a plan view of an undercarriage of a vehicle incorporating an embodiment of the present invention.

### DESCRIPTION OF THE EXEMPLARY EMBODIMENTS

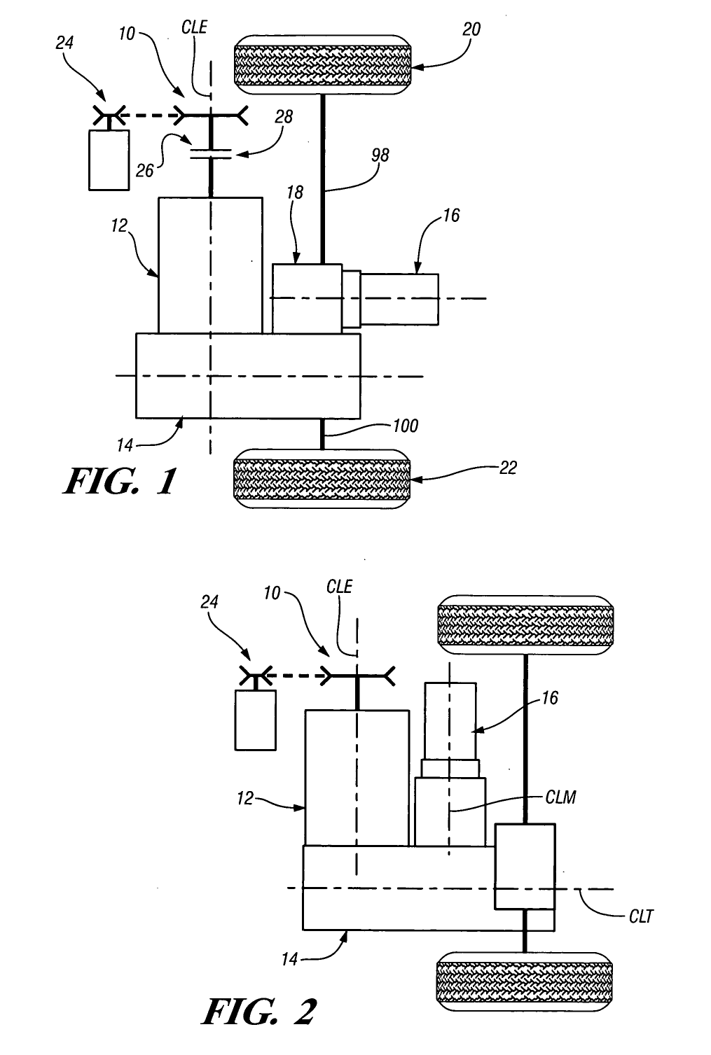

Referring to the drawings, wherein like characters represent the same or corresponding parts throughout the several views, there is seen in FIG. 1 a hybrid powertrain generally designated 10, which includes an engine 12, a multi-ratio transmission 14, an electric power transfer machine or unit 16, a gear assembly mechanism (commonly referred to as a “power take-off unit”) 18, a pair of drive wheels 20 and 22, and a belt-alternator-starter (BAS) mechanism 24. The electric power transfer machine 16 may be a conventional motor/generator (M/G).

The engine 12 is a conventional internal combustion engine. The transmission 14 may be any of a number of variable ratio transmission designs such as continuously variable transmissions, automatic transmissions incorporating planetary gearsets, or manual transmissions incorporating a plurality of meshing ratio gearsets. These types of transmissions, as well as other variable ratio transmissions, are well known to those skilled in the art and their construction and operation is a matter of record within the prior art.

The BAS 24 is drivingly connected to an input shaft 26 of the engine 12 through an electromagnetic or other selectively engageable clutch 28. The BAS 24 can be employed as either a motor or a generator. When operating as a motor, it is energized to start the engine 12 and when used as a generator, it supplies electrical energy for various operating mechanisms within the engine and transmission.

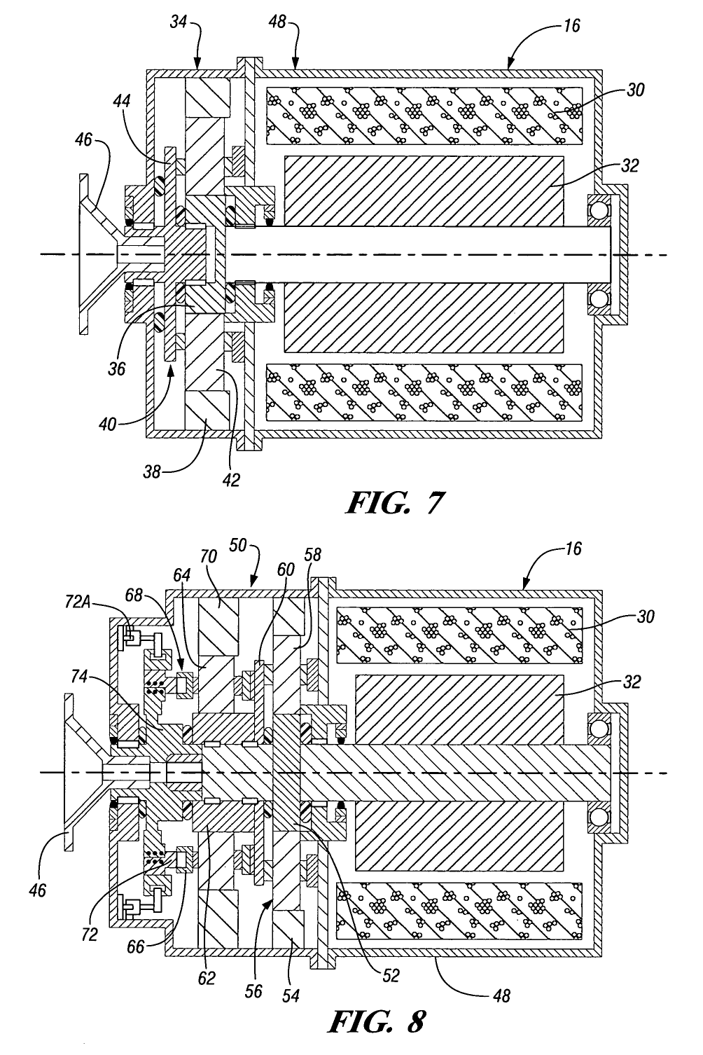

The electric power unit 16 is constructed in a manner similar to that shown in FIGS. 7 and 8. In FIG. 7, the electric power unit 16 includes a stator 30, a rotor 32, and a gear reduction mechanism 34. The gear reduction mechanism 34 has a sun gear member 36, a ring gear member 38, and planet carrier assembly member 40. The planet carrier assembly member 40 includes a plurality of pinion gears 42 rotatably mounted on a planet carrier member 44. The planet carrier member 44 is drivingly connected with a yoke 46.

The ring gear member 38 is continuously connected with a housing 48 that encloses both the electric power unit 16 and the planet carrier assembly member 40. When the electric motor unit 16 is powered, the rotor 32 drives the sun gear member 36, which in turn causes a reduced speed and torque increase to the yoke 46 through the planet carrier member 44. Such an operation is conventional within planetary transmissions.

The electric power unit 16 shown in FIG. 8 includes a stator 30, a rotor 32, and a planetary reduction unit 50. The planetary reduction unit 50 includes a sun gear member 52 continuously drivingly connected with the rotor 32, a ring gear member 54, and a planet carrier assembly member 56. The planet carrier assembly member 56 includes a plurality of pinion gears 58 rotatably mounted on a planet carrier member 60.

The planet carrier member 60 is continuously connected with a sun gear member 62. The sun gear member 62 meshes with a plurality of pinion gears 64 rotatably mounted on a planet carrier member 66, which are components of a planet carrier assembly member 68. The pinion gears 64 also engage a ring gear member 70 that is continuously drivingly connected with the housing 48, as is the ring gear member 54.

The planet carrier member 66 is connected, through a conventional torque transmitting mechanism such as a mechanical clutch 72, with a hub 74, which in turn is connected to the yoke 46. The clutch 72 is a selectively engageable mechanism and may either be a dog clutch, a synchronized clutch, a friction clutch, or an electromagnetic clutch. The preferable design is a dog clutch with an electrical actuator, which is the least expensive and the easiest to operate. In either event, the clutch is operated by an electromechanical actuator 72A not described in detail. Since the speed of the rotor 32 can be easily controlled by a hybrid control system, the clutch 72 can be engaged at synchronous speeds. A synchronous speed will occur when the speed of the rotor 32 is accelerated or decelerated and electric motor yoke 46 speed equals the speed of gear assembly yoke 46′.

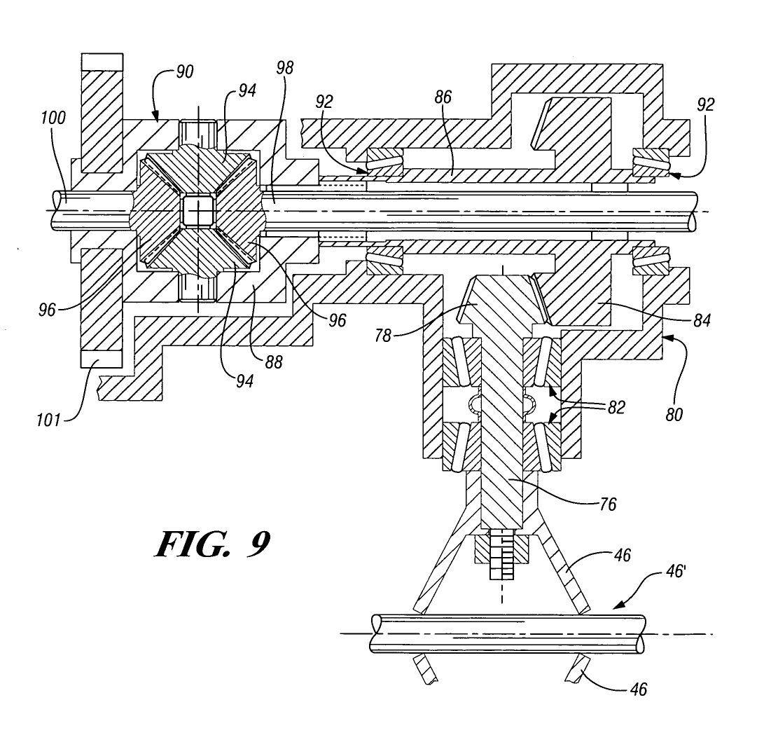

As seen in FIG. 9, the yoke 46′ is connected through a shaft 76 with a bevel gear 78. The shaft 76 is supported in a housing 80 by a pair of tapered roller bearings 82. The bevel gear 78 meshes with a bevel gear 84, which is drivingly connected through a shaft 86 with a differential carrier 88 of a conventional differential mechanism 90. The shaft 86 is rotatably supported in the housing 80 by a pair of tapered roller bearings 92.

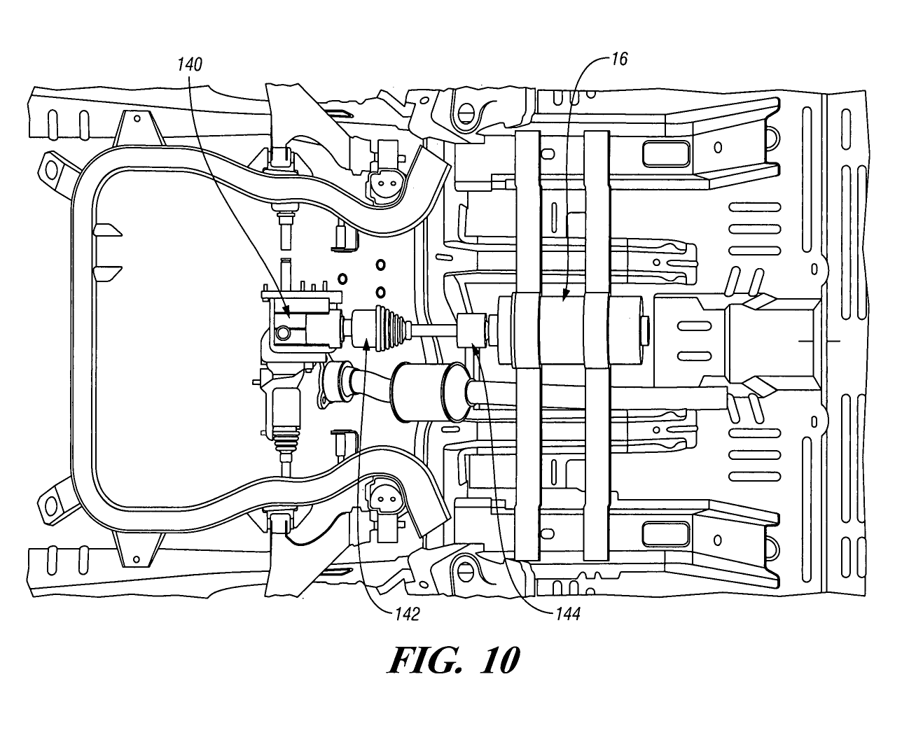

As seen in FIG. 10, yokes 46 and 46′ may be eliminated and electric motor 16 can be attached to the power take-off gear assembly 140 via CV joints 142 and 144 what may be dictated by packaging requirements.

The differential mechanism 90 has a pair of pinion gears 94 meshing with a pair of side gears 96. The pinion gears 94 are rotatable with the carrier 88. The carrier 88 is driven by the output of the transmission through a gear member 101. This is a conventional drive connection and, in fact, most front wheel drive applications have a differential mechanism incorporated therein and rear wheel drive applications can have such a mechanism incorporated and do, in fact, have such a mechanism, which might be incorporated into a transfer case when four-wheel drive or all wheel drive systems are needed.

The side gear 96, which meshes with the pinion gears 94, is continuously connected with a powertrain output shaft 98, which is connected with one of the driven wheels 20, 22 of the hybrid powertrain 10. The other side gear 96 is drivingly connected with a shaft 100, which is drivingly connected with another of the drive wheels 22, 20. In FIG. 1, the shaft 98 is shown as the axle shaft for the driven wheel 20 and the shaft 100 is shown connected with the driven wheel 22.

With the arrangement shown in FIG. 9, the differential carrier 88 may be driven by either the electric power unit 16 or by the engine 12 through the transmission 14. If motor-only operation is desired, the transmission 14 can be placed in neutral thus no back-drive to the engine 12 will be present.

With the construction shown in FIG. 1, the centerline of the transmission (CLT) is parallel with the centerline of the motor (CLM) of the electric unit 16 and perpendicular to the engine centerline CLE.

Another embodiment of the hybrid powertrain 10 is shown in FIG. 2 wherein the centerline CLM of the electric unit 16 is parallel with the centerline CLE of the engine 12. In both systems, a BAS system 24 is included to provide engine starting and electrical regeneration. The electric power unit 16 will also provide electric regeneration during regenerative braking processes.

In the embodiment described in FIG. 2, the transmission centerline CLT is perpendicular to the electric unit centerline CLM. In either embodiment, the structures described above for FIGS. 7 or 8, and 9 can be employed to connect the electric power unit 16 to the output of the transmission 14.

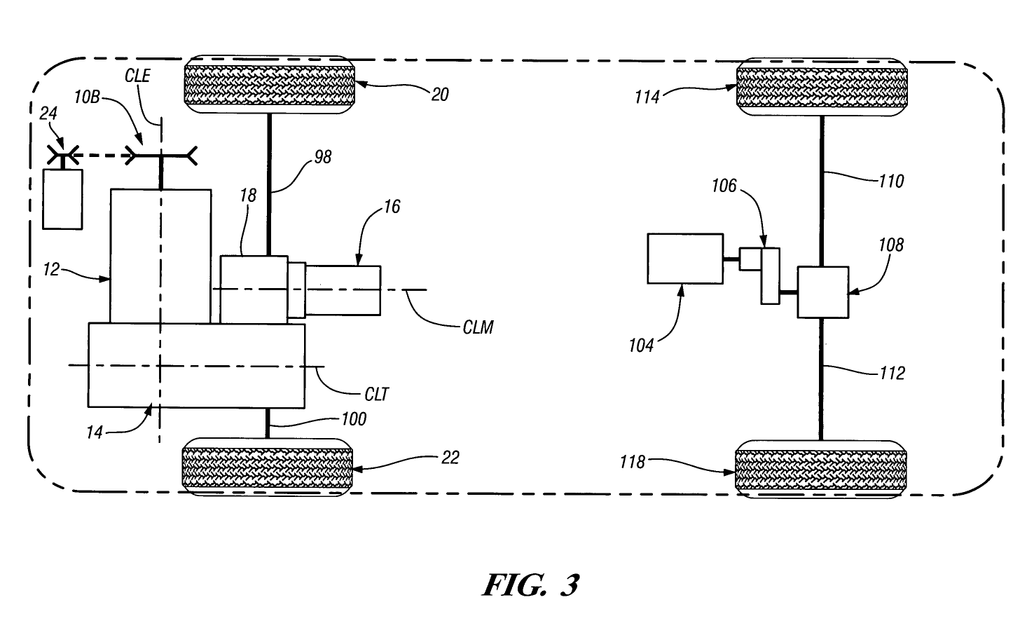

A powertrain 10B shown in FIG. 3 includes the powertrain arrangement shown in FIG. 1 wherein the electric unit centerline CLM is parallel with the transmission centerline CLT. However, to provide an all wheel drive or four-wheel drive application, a separate electric unit 104 is drivingly connected through a gear reduction unit 106 to a rear differential 108. A conventional rear differential 108 is drivingly connected to shafts 110 and 112 to vehicle wheels 114 and 116, respectively.

In FIG. 3 the vehicle wheels 20, 22, 114, and 116 can be driven whenever it is desired to operate the vehicle or the wheels driven by the electric unit 104 can be controlled to input power to the wheels 114 and 116 only when the wheels 20 and 22 are either slipping and/or power provided to front wheels is lower than power demand.

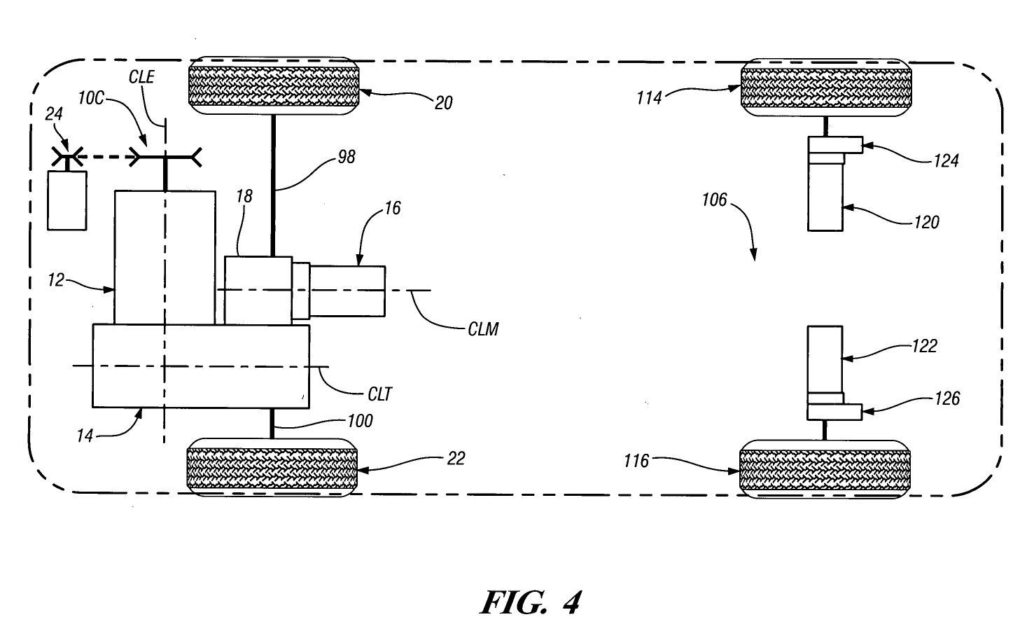

A powertrain 10C shown in FIG. 4 incorporates the hybrid powertrain described in FIG. 1 above with a rear wheel drive application, which is accomplished by two electric drive units 120 and 122. The electric drive unit 120 drives a vehicle wheel 114 through a reduction unit 124. The electric drive unit 122 drives the vehicle wheel 116 through a conventional gear reduction mechanism 126.

The powertrain 10C shown in FIG. 4 has the advantage of permitting independent drive at each of the rear wheels 114, 116. Thus, the rear wheels 114 and 116 can be driven in unison or at different speeds, if desired, or one wheel can be driven and the other remain undriven but rolling freely. The electric units 120, 122, 104, and 16 will all provide electrical energy during regenerative braking. The electrical energy provided during regenerative braking as is well known can be utilized to charge batteries within the vehicle and/or maintain electrical systems operable during vehicle braking.

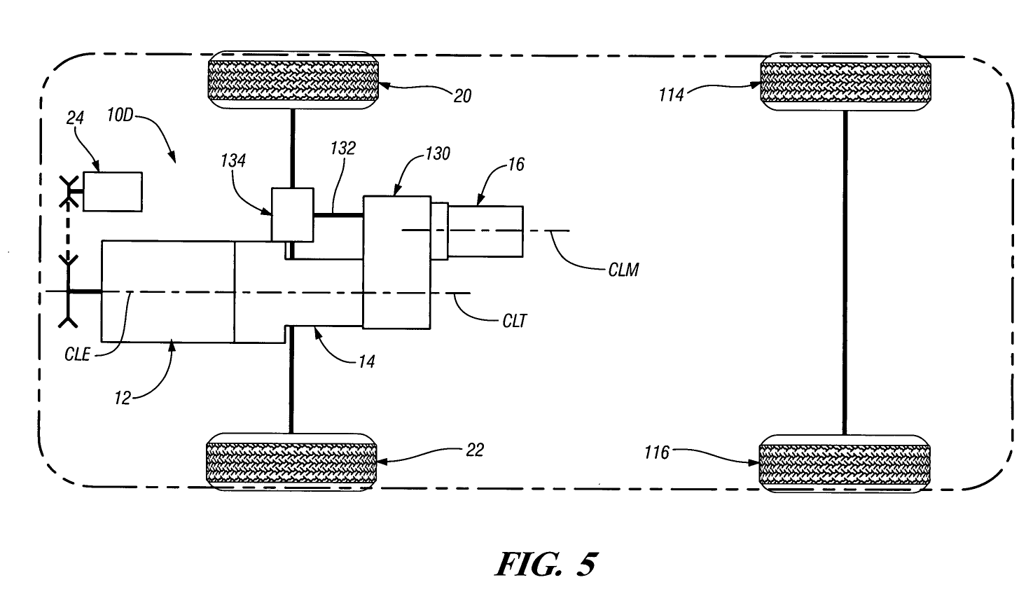

A powertrain 10D shown in FIG. 5 incorporates what is commonly termed a longitudinal engine and transmission arrangement. In such an arrangement, the engine centerline CLE and the transmission centerline CLT are parallel with the vehicle centerline, not shown. In such a system, the present invention is employed by mounting the electric power unit 16 to a conventional transfer case 130.

As is well known, the transfer case 130 provides a continuous drive from the output of transmission 14 to a shaft 132, which in turn drives a front wheel differential 134. The differential 134 is a conventional device well known to provide a drive spread to the front wheels 20 and 22. The motor drive into the transfer case is similar to that shown in FIG. 9. With the powertrain 10D shown in FIG. 5, the rear wheels 114 and 116 are not driven and simply rotate with the vehicle as it moves across the terrain.

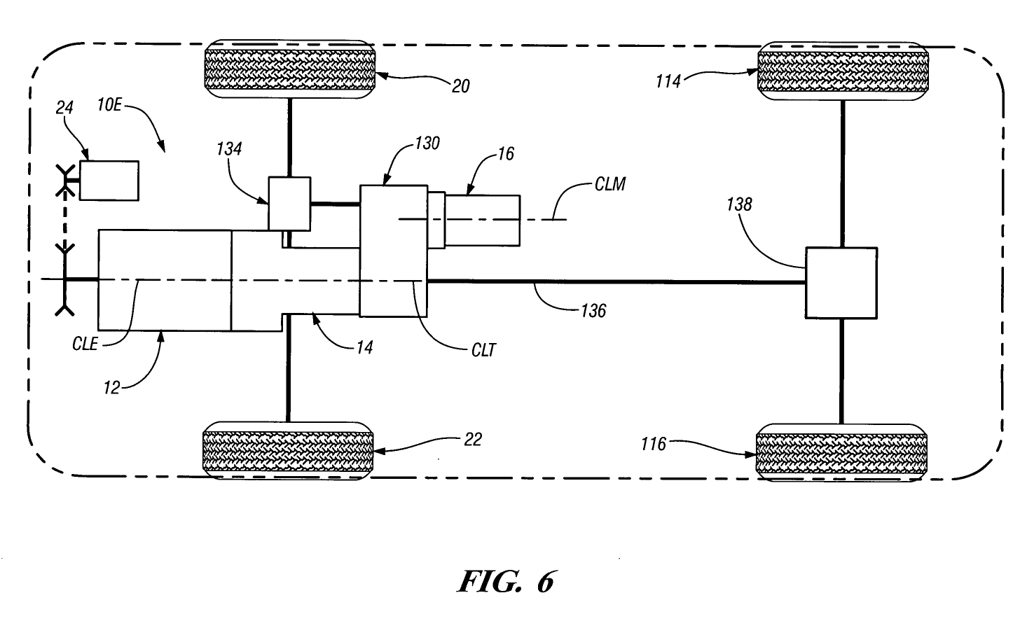

A powertrain 10E shown in FIG. 6 incorporates a longitudinal drive mechanism for the engine 12 and transmission 14 similar to that described above for FIG. 5. The powertrain 10E, however, is designed to provide an all wheel or four-wheel drive operation wherein the rear wheels 114 and 116 are driven through a shaft 136 using a conventional transfer case 130. The shaft 136 drives a conventional differential 138, which in turn drives the rear wheels 114 and 116 in a conventional manner. As with the other hybrid powertrain systems shown, the electric units 16 in FIGS. 5 and 6 are employed to provide regenerative vehicle braking.

It should now be apparent that in all of the powertrain systems described above, the electric power unit 16 is drivingly connected at the transmission output. Thus, the engine and transmission can be placed in a nondrive condition, for example, the transmission in neutral and the engine off, when a motor-only drive system is desired. In some instances, the engine and/or transmission might become inoperable either through lack of fuel or some other malfunction, in which case the electric unit 16 can provide motor force for the vehicle to transfer the vehicle to a repair location.

Also, it should now be appreciated that during vehicle braking, the speed of the electric power unit 16 is not affected by the transmission ratio and can be disconnected therefrom by placing the transmission in neutral. This is not possible with other full hybrid powertrains. In other full hybrid powertrains, the electric power unit 16 is incorporated into the transmission 14 and/or disposed between the transmission 14 and the engine 12.

1. A hybrid powertrain comprising:
a prime mover engine, a multi-ratio transmission driven by said prime mover;
a gear transfer mechanism between said transmission and a plurality of vehicle drive wheels; and
an electric power unit drivingly connected with said gear transfer mechanism in parallel power flow relation with an output power flow from said transmission.

2. The hybrid powertrain defined in claim 1 further wherein:
said electric power unit incorporates a reduction gear mechanism between an output member of said electric power unit and said gear transfer mechanism.

3. The hybrid powertrain defined in claim 1 further wherein:
said electric power unit incorporates a reduction gearing disposed to provide input drive to said gear transfer mechanism through a selectively engageable torque-transmitting mechanism.

4. The hybrid powertrain defined in claim 1 further wherein:
said electric power unit has a centerline disposed in parallel relationship with a centerline of said transmission.

5. The hybrid powertrain defined in claim 1 further wherein:
said electric power unit has a centerline disposed in perpendicular relationship with a centerline of said transmission.

6. The hybrid powertrain defined in claim 1 further wherein:
a transfer gearing mechanism is disposed between said transmission and said driven wheels of a vehicle; and
said electric power unit provides an input drive through a reduction gearing to said reduction gear mechanism and therefore to said driven wheels of said vehicle through a power path parallel with a power path from said transmission.
